(19) United States
(12) Patent Application Publication
(10) Pub. No.: US 2026/0294740 A1
(43) Pub. Date: Oct. 1, 2026

(54) BAG FOR A PHARMACEUTICAL OR NUTRITIONAL PRODUCT COMPRISING A PORT COVERED BY A BARRIER LAYER

(71) Applicant: B. Braun Melsungen AG, Melsungen (DE)

(72) Inventor: Denis Loewensberg, Chexbres (CH)

(21) Appl. No.: 19/630,801

(22) Filed: Mar. 27, 2026

(30) Foreign Application Priority Data
Mar. 31, 2025 (EP) 25167404.0

(51) Int. Cl. A61J 1/10; A61J 1/14

(52) U.S. Cl. CPC A61J 1/10; A61J 1/1468; A61J 1/1475

(57) ABSTRACT

A bag suitable for housing a pharmaceutical product or a nutritional product has two walls and at least one port. Each wall has at least one edge and a barrier layer. The two walls are superimposed on each other and connected by at least one connection, forming an inner cavity. At least 90% of an outer surface of the at least one port is covered by the barrier layer.

### CROSS-REFERENCE TO RELATED APPLICATION

This application claims priority under 35 U.S.C. § 119 to European Application No. 25167404.0, filed on Mar. 31, 2025, the content of which is incorporated by reference herein in its entirety.

### FIELD

The present disclosure relates to bags suitable for housing a pharmaceutical product or a nutritional product, and more specifically, to bags containing a pharmaceutical product or a nutritional product.

### BACKGROUND

In the prior art, it is common to package a pharmaceutical product or a nutritional product within a primary bag made of plastic, or other suitable materials, preferably flexible plastic, or other flexible suitable materials. Such bags are designed to hold a specific dose of the product and allow for easy parenteral or enteral administration, while primary bags serve to contain and facilitate the use of the product, the nature of many pharmaceutical or nutritional substances necessitates additional protective measures to maintain product integrity and efficacy.

To address these concerns, prior art solutions commonly employ secondary packaging, which encases the primary bags. The secondary packaging may be made of foil, plastic, or a combination of flexible materials, often selected for their barrier properties against for e.g. moisture, light, oxygen, carbon dioxide and contamination. For example, many pharmaceutical and nutritional bags are sealed in individual foil pouches. This secondary layer not only provides additional protection from environmental factors but also helps to preserve the freshness, potency, and shelf life of the active ingredients within the primary bag.

Furthermore, secondary packaging plays a critical role in compliance with regulatory standards for the packaging of pharmaceutical and nutritional products. In particular, for products with sensitive ingredients such as active pharmaceutical ingredients, probiotics, or vitamins the secondary packaging helps to mitigate degradation or contamination risks, ensuring a product with consistent quality and efficacy over time.

However, while secondary packaging offers clear benefits in terms of protection and stability, it can also introduce challenges related to environmental sustainability and material waste. Traditional secondary packaging materials, such as aluminum foil or multilayer plastic composites, are often not recyclable or biodegradable, contributing to a growing concern about the environmental impact of single-use packaging in the medicinal and nutritional industries.

There is, therefore, a need for improved solutions that offer the protective benefits of secondary packaging while addressing environmental and sustainability concerns, without compromising the stability, safety, and efficacy of the medicinal or nutritional products contained within the primary bags.

As a solution, the prior art provides primary bags for pharmaceutical or nutritional products, wherein the primary packaging is combined, i.e. laminated or coextruded, with a barrier film. Such modified primary barrier bags protect oxygen sensitive or carbon dioxide sensitive solutions or powders. Hence, usually, such bags are made from flexible multilayer barrier films and one or more ports for filling, drug adjunction, or drug delivery. The ports are connected by welding to the primary film. As such, a secondary packaging is not necessarily needed anymore.

### SUMMARY

The aforementioned solution has the disadvantage that the ports welded into the multilayer film provide a leak for e.g. oxygen to permeate into the inner cavity of the bag and deteriorate the products thereon. It has now been found out that these ports even work as a kind of chimney, therefore being responsible for much more deterioration as assumed before.

Hence, it is an object of the present disclosure to provide a bag for pharmaceutical or nutritional products, which comprises a barrier film in the primary film and at least one port welded therein, and which does not provide a barrier leak at the port.

It has now surprisingly found out that above-mentioned object is achieved by a bag suitable for housing a pharmaceutical product or a nutritional product, the bag comprising two walls and at least one port, wherein each wall has at least one edge, wherein each wall comprises a barrier layer, wherein the walls are superimposed on each other, wherein the walls are connected by at least one connection at or close to the at least one edge of each of the two walls, thereby forming an inner cavity, and wherein at least 90% of an outer surface of the at least one port are covered by the barrier layer.

The advantage of the present disclosure is that the port, in particular any neck of the port, is covered by the multilayer film of the primary bag comprising a barrier layer. Thus, any permeation therethrough can be significantly reduced if not stopped at all.

### BRIEF DESCRIPTION OF THE DRAWINGS

FIG. 1a is a schematic representation of a preferred embodiment of the bag of the present disclosure comprising a closure 15 being plugged into the port.

FIG. 1b is another perspective of the bag of the embodiment according to FIG. 1a.

FIG. 2a is a schematic representation of a preferred embodiment of the bag of the present disclosure comprising a closure 15 being combined with the port and a port having a boat-like shape.

FIG. 2b is another perspective of the bag of the embodiment according to FIG. 2a.

FIG. 3a is a schematic representation of a preferred embodiment of the bag of the present disclosure comprising a closure 15 being formed inside the inner port cavity.

FIG. 3b is another perspective of the bag of the embodiment according to FIG. 3a.

FIG. 4 is schematic representation of a preferred embodiment of the bag of the present disclosure comprising an overmolded stopper.

FIG. 5a shows an example of a cap and tamper evidence means for the bag according to FIG. 4, with welded tamper evidence with folded opening tab on the primary film.

FIG. 5b shows an example of a cap and tamper evidence means for the bag according to FIG. 4, with welded tamper evidence wrapping the area of the films welded to the port.

FIG. 6a shows an example of a cap and tamper evidence means for bags according to the present disclosure, with a circular cap completely covered by the tamper evidence means.

FIG. 6b shows an example of a cap and tamper evidence means for bags according to the present disclosure, with a circular cap partially covered by the tamper evidence means.

FIG. 6c shows an example of a cap and tamper evidence means for bags according to the present disclosure, with a circular cap and folded and tilted tamper evidence means.

FIG. 6d shows an example of a cap and tamper evidence means for bags according to the present disclosure, with an oval cap and folded and tilted tamper evidence means.

FIG. 7 is a schematic representation of a preferred embodiment of the bag of the present disclosure comprising a closure being formed inside the inner port cavity wherein the port is a twin port.

FIG. 8a shows an example of the bags according to the present disclosure in connection with a spike, according to the embodiments in FIGS. 1a, 1b, 2a and 2b.

FIG. 8b shows an example of the bags according to the present disclosure in connection with a spike, according to the embodiments in FIGS. 3a and 3b.

### DEFINITIONS

The term ‘polymer’ as used herein denotes an organic polymer, preferably a polymer selected from polyolefins, polyethylene terephthalate, polystyrene, polyvinyl chloride, or mixtures thereof, more preferably a polyolefin selected from the list consisting of polyethylene, polypropylene, or mixtures thereof.

The term ‘liquid-tight’ as used herein denotes a quality of an object to function as a barrier for a liquid, preferably for a water-based liquid.

The term ‘barrier layer’ as used herein denotes a material, which can slow down the process of oxygen permeation. Preferably, it comprises, more preferably consists of, a base barrier material, most preferably ethylene-vinyl alcohol (EVOH), or a metal oxide material, most preferably a silicon oxide layer or an aluminum oxide layer. Such barrier layer can require a supporting or binding layer to adhere thereto. Metal oxide-based layers can be deposited directly onto the polymer material (e.g., by chemical vapor deposition).

The term ‘welding’ as used herein denotes thermal welding of liquid-tight film comprising a polymer material. In this process, at least two liquid-tight films comprising a polymer material are heated until at least the glass transition temperature is reached and the polymer in these areas begin to become liquid or at least low viscous. By simultaneous or subsequent mechanical pressing of these areas, the polymers are mixed together at this point and, after cooling and solidification, form a fixed joint called a seam. The seam can be permanent or a rupturable seam. The latter is advantageous in case the bag should be openable at the seam.

The term ‘active pharmaceutical ingredient (API)’ as used herein denotes a substance preferably provided in a pharmaceutical product that is biologically active and responsible for producing intended therapeutic effects. APIs are the key ingredients in medications that treat, diagnose, or prevent diseases. For example, in a pain relief medication like ibuprofen, ibuprofen itself is the API, while other components in the formulation (excipients) may help with the drug’s stability, absorption, or delivery. APIs can be small molecules or large molecules such as proteins or antibodies.

The term ‘additive’ as used herein denotes further components, which can be present in polymer compositions to modify their physical properties. Examples of additives are antioxidant(s), stabilizer(s), such as process stabilizers and UV stabilizers, acid scavenger(s), metal deactivators, crosslinking agents, such as free radical generating agent(s), e.g., organic peroxide(s), scorch retarder(s), crosslinking booster(s), processing aid(s), flame retardant additive(s), water tree retardant additive(s), inorganic filler(s), and voltage stabilizer(s). These groups of additives and the individual additive compounds therein are usually well known in the polymer field.

The term ‘sterile’ as used denotes the status of an object having a significantly reduced number of bacteria and/or viruses on its surface or in the material to reduce the risk of an infection. In particular, the term ‘sterile’ denotes an object or substance, which has a bioburden load of lower than 10⁻⁶. The bioburden load can be measured i.e., according to ISO 11737-1:2018.

The term ‘sterilization’ as used herein denotes a method to destroy all forms of living microorganisms from a substance. As there is always a certain probability of at least one microorganism to survive such procedure, the aim of sterilization is the reduction of initially present microorganisms or other potential pathogens. Generally, sterilization is accepted to be achieved if the bioburden load of the substance of object to be sterilized is lower than 10⁻⁶. The bioburden load can be measured i.e., according to ISO 11737-1:2018. Sterilization can be achieved using several methods. In one sterilization process the object is heated up to at least 105 °C to achieve a sterile object. Thereby, the object should not be deformed by the elevated temperature. Preferably, the heating step is performed in an autoclave. In another sterilization process, the object is brought into contact with toxic gases such as a mixture of ethylene oxide and carbon dioxide. Filtration methods are also used to sterilize liquids, i.e., by using membrane filters, Seitz filters, and/or candle filters. Finally, sterilization can be achieved by indirect energy import into or onto the object, e.g., by ultrasonic waves, ultraviolet light, as well as by high energy particles (such as electrons, gamma- or X-rays).

The term ‘seam’ as used herein denotes an area of at least two connected walls including at least one edge of each wall of a bag at which the two walls are connected, i.e., by gluing or welding, thereby forming a seam area, a seam edge, and an inner boundary of the edge.

The term ‘seam width’ as used herein denotes the distance between the seam edge and the inner boundary of the seam in a direction perpendicular to the seam edge. Usually, the seam width is substantially homogeneous, i.e., does not vary in the direction of the seam edge. However, variation of the seam width can be part of the overall design of a bag.

The term ‘wall’ as used herein denotes the flexible or rigid surfaces (sides, bottom, and sometimes the top) that define the boundaries of the wall, in particular the inner cavity of the bag. Usually, the walls are connected to each other i.e., by gluing or welding, to form a liquid-tight cavity. The walls might hold further equipment, such as a port. The walls might be rigid or flexible. Preferably, the walls are flexible.

The term ‘inner cavity’ as used herein denotes a space, which is defined by the bag, in particular by the walls and their connections. In certain cases, also other parts of the bag might additionally define the inner cavity. For example, if a port is included in a connection, it also contributes to the definition of the inner cavity.

The term ‘oxygen depleted gas’ denotes a gas, which has a lower concentration of oxygen than air, preferably no or only trace amounts of oxygen. Hence, preferably, the oxygen depleted gas comprises, preferably consists of, a gas selected from nitrogen, carbon dioxide, a noble gas, or mixtures thereof. Most preferably, the oxygen depleted gas comprises, preferably consists of, nitrogen.

The term ‘port’ as used herein denotes an opening in a bag for introducing or removing material. Typically, a port comprises an insert which is rigid, and which defines the pathways for introducing or removing material. A port can have more than one of these pathways. Hence, for example, ports having two pathways are usually called twinports, whereas ports having only one pathway are usually called monoports. Typically, ports are formed as prisms having curvilinearly shaped bases. Most commonly, the curvilinearly shaped bases are circles for monoports and ovals, preferably ellipses for twinports. For both monoports and twinports also pointed ovals, preferably pointed symmetric ovals, are used.

The term ‘curvilinearily shaped’ or ‘curvilinear shape’ denotes a shape, which comprises smooth curves. The shape may also comprise pointed ends as long as the transitions between these pointed ends are curvilinear.

The term ‘boat-like shaped’ denotes the shape of a port, which has a pointed oval, preferably a pointed symmetric oval, as curvilinearily shaped base for its prism shape.

The term ‘outer surface of the port’ as used herein denotes the lateral surface of the prims shape of the port.

### DETAILED DESCRIPTION

As set out above, the most general embodiment of the present disclosure relates to a bag (1) suitable for housing a pharmaceutical product or a nutritional product, the bag comprising two walls (2) and at least one port (3),

wherein each wall (2) has at least one edge (4),

wherein each wall (2) comprises a barrier layer (5),

wherein the walls (2) are superimposed on each other,

wherein the walls (2) are connected by at least one connection (6) ()of the two walls (2), thereby forming an inner cavity (7), and

wherein at least 90% of an outer surface (8) of the at least one port (3) are covered by the barrier layer (5).

Exemplary embodiments of such a bag have been depicted in the Figures. Preferably, as much of the outer surface (8) of the at least one port (3) as possible is covered by the barrier layer (5). Hence, preferably at least 95%, more preferably at least 99%, even more preferably at least 99.9%, and most preferably at least 100%, of the outer surface (8) of the at least one port (3) are covered by the barrier layer (5). With increasing percentage of the outer surface of the port being covered by the barrier layer the permeation through the port is reduced.

The bag according to the present disclosure comprises at least two walls (2). Hence, the bag according to the present disclosure may contain more than two walls (2), which are connected by connection (6) to form the inner cavity (7). Most preferably, the bag according to the present disclosure comprises two walls (2), which are preferably connected at their edges (4) by connections (6) to form the inner cavity (7). Thereby, preferably, the inner cavity (7) is completely enclosed by the barrier layer (5) of the two walls (2). Usually, these connections are called seams. Usually, the seams of the bag according to the present disclosure can be formed by any method allowing for a liquid-tight connection. Preferably, the seams are formed by gluing or by welding. Most preferably, the seams are formed by welding, i.e., by plastic welding or ultrasonic welding. Usually, the seams are present as a plane, i.e., a flat area, in which the two entities to be connected, i.e., two walls, constantly are in contact with each other. Depending on the use case, this area can be enlarged, i.e., to attach further equipment, print information thereon, or stance orifices therein. Usually, the seams, which are used for forming the connection (6) and definition of the inner cavity (7) only, should not be too small, as the liquid-tightness of the seam depends on the size of the area of contact, but also not too large, as otherwise the size of the bag gets too large without any further volume increase wasting space in the storage areas and increasing the amount of material consumption and waste. Hence, preferably, the seam has a seam width of equal to or more than 2 mm, preferably equal to or more than 3 mm, and most preferably equal to or more than 6 mm. Usually, the seam has a seam width of not more than 10 mm.

In another preferred embodiment, the shape of the at least two walls (2) of the bag according to the present disclosure is rectangular. Preferably, the walls (2) have the same shape.

Thus, in a most preferred embodiment of the bag according to the present disclosure, the bag comprises two walls, which have a rectangular shape, therefore forming linear edges (4), and which have the same shape, wherein the two walls (2) are connected by seams as connections (6) at their edges (4). Preferably, the seam width is constant and is in the range of from 1 to 10 mm, preferably in the range of from 2 to 6 mm. Such a design allows for saving material in the seam area of the bag, therefore enhancing the sustainability of the bag.

Generally, the port (3) of the bag can be positioned at either any point of the at least two walls (2) or at any point of the connection (6). Preferably, however, the port is positioned at the connection (6) as it facilitates the production process of the bag according to the present disclosure. The port is preferably a tube, more preferably an extruded tube or a molded tubular component welded or glued into the connection 6), preferably seam, of the bag, whereby the port preferably does not extend outwardly from the connection (6).

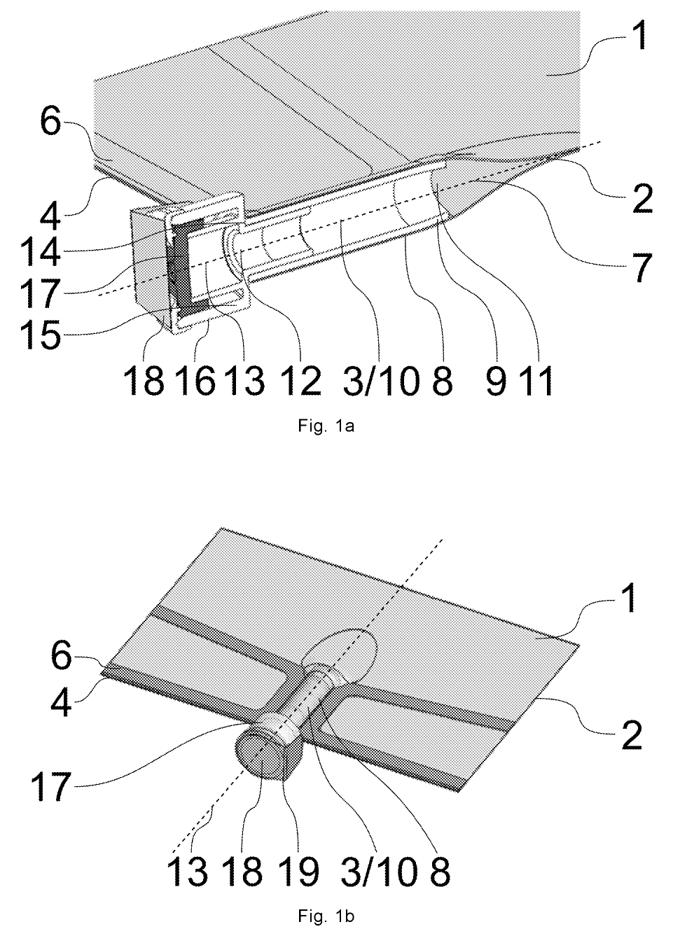

As can be seen in FIGS. 1a, 2a, and 3a, preferably, the port (3) is included into the at least two walls (2) of the bag (1). This is preferably achieved by including the port (3) in the connection (6) between the at least two walls. Thereby, the port could be fully included in such a connection. This, however, has the disadvantage that the connection usually has to be relatively broad and thus difficult to be produced. Hence, preferably, the bag has two connections spaced apart from each other, wherein the port (3) is included in both connections (6). Even more preferably, at least one third connection is present, which connects both connections, and which extends along the lateral surface of the port (3). Such an embodiment is shown in all Figures.

Preferably, the inner cavity (7) of the bag comprises the pharmaceutical product or the nutritional product.

The port preferably comprises a rigid insert, which defines the pathways for introducing or removing material. Preferably, the shape of the port is a prism having at least partially curvilinearly shaped bases. Most preferably, the curvilinearly shaped bases are circles for monoports and ovals, preferably ellipses for twinports. For both monoports and twinports also pointed ovals, preferably pointed symmetric oval, i.e. boat-like shaped ports, can be used. Hence, preferably, the port (3) has a tubular shape or a boat-like shape, more preferably a boat-like shape. This has the advantage that the at least two walls (2) can be connected to the outer surface (8) of the port (3) with least tension and knits preventing barrier layer rupture by the welding tool. Alternatively, the tubular shape or a boat-like shape can be additionally conical shape, which facilitates manual handling.

Hence, the port (3) comprises at least one port wall (9) forming an inner port cavity (10) wherein the port (3) has an inlet opening (11) and an outlet opening (12) defining an axis (14) of the port (3) wherein the port (3) is positioned between the two walls (2) through the at least one connection (6), wherein the inlet opening (11) points towards the inner cavity (7) of the bag (1), preferably towards the center of the inner cavity (7) of the bag (1). It should be understood that the axis is defined in case of a monoport in that the axis extends through the center of the inlet opening (11) and through the center of the outlet opening (12). In a case of a twinport, the axis extends through the point having the two smallest distances to the centers of the two inlet openings (11) and through the point having the two smallest distances to the centers of the two outlet openings (12).

Usually, the port (3) is made from a polymer material. Preferably, the port (3) is produced by injection molding, molding compression or by co-injection. Preferred polymers used for the polymer material of the port (3) are polyethylene or polypropylene, preferably polypropylene. The polypropylene of port (3) is preferably a low melting point polypropylene offering a good weldability on the barrier film.

In a preferred embodiment of the present disclosure, the polymer material of the port (3) can already have barrier properties. Such barrier properties of the polymer material of the port (3) can be provided by EVOH or other barrier materials in combination with polypropylene or polyethylene. The use of a tie layer as individual layer or a binder mixed into the based material may be needed to achieve the adhesion with EVOH or other barrier materials. Such an embodiment has the advantage that any permeation through the port (3) can be further reduced.

Alternatively, the outer surface (8) of the port (3) comprises ribs (21).

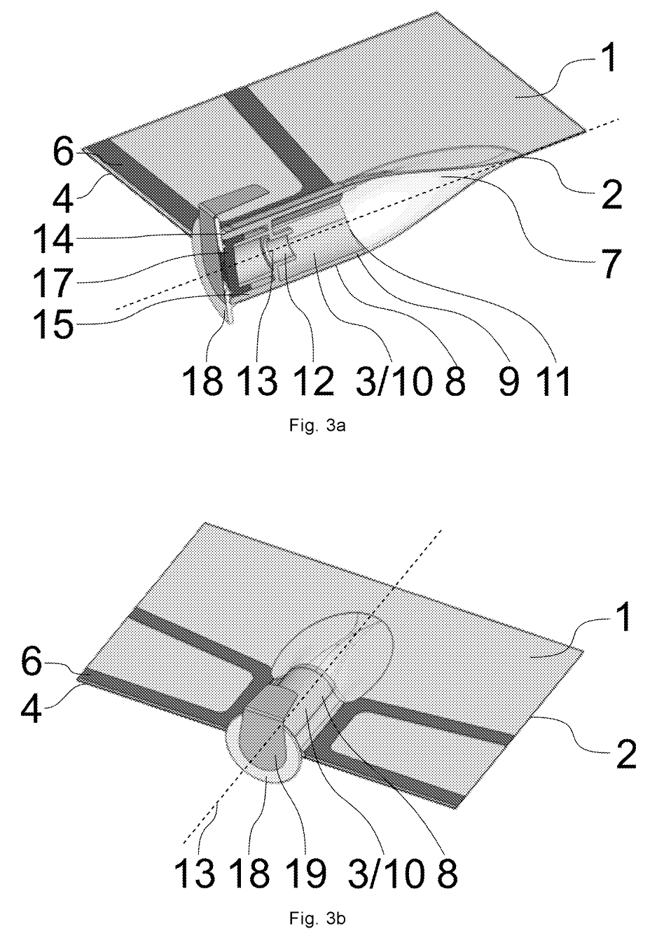

Preferably, the at least one port wall (10) of the port (3) has at least one port edge (14) defining the outlet opening (12), wherein the at least one port edge (14) and the at least one edges (4) of each of the two walls (2) are in alignment. This ensures that the outer surface (8) of the port is completely, i.e. to 100%, covered by the barrier layer (5) and results in a maximum reduction of permeation. Respective implementations thereof can be seen in FIGS. 1a, 1b, 3a, and 3b, and others.

In an especially preferred embodiment of the bag according to the present disclosure, the shape of the at least two walls (2) is a rectangular shape, wherein the at least two walls (2) have the same shape, wherein the at least two walls (2) are superimposed on each other so that each edge (4) of each of the two walls (2) is in alignment, wherein the port (3) is positioned so that the axis (13) of the port (3) forms an angle in the range of from 60 to 120°, preferably 65 to 115°, more preferably 70 to 110°, even more preferably 80 to 100°, still even more preferably 85 to 95°, and most preferably 89 to 91°,to the edge (4) closest to the connection (6), through which the port (3) is positioned. Such an embodiment has the advantage that introduction and removal of compounds in or from the bag are facilitated. This is even more improved, if the port (3) is positioned in the middle of the edge (4) closest to the connection (6), through which the port (3) is positioned.

In a preferred embodiment of the present disclosure, the at least two walls (2) are made from a liquid-tight film, wherein the liquid-tight film preferably comprises, more preferably consists of, a polymer material. The polymer material is preferably selected from the list consisting of polyethylene, polypropylene, polyethylene terephthalate, polyamide, ethylene vinyl alcohol, or mixture thereof. More preferably the polymer material is selected from polyethylene or polypropylene. These materials have an ideal balance of material properties, processability, inertia in view of the drug, and low price. Additionally, the liquid-tight film can preferably comprise one or more additives. Preferably, the polymer material is a weldable polymer material.

Preferably, the liquid-tight film has a haze value measured according to ASTM D1003, Procedure B, of less than 60%, preferably less than 30%, more preferably less than 25%, and most preferably less than 15%. This ensures that the user can easily control the filling status of the bag as used in the API for use in a treatment of a patient according to the present disclosure.

Preferably, the polymer material of the liquid-tight film has a glass transition temperature T g measured according to ASTM D3418, of not more than 80 °C, preferably not more than 60 °C, more preferably not more than 40 °C, and most preferably not more than 20 °C. This ensures thermal stability in particular in view of the sterilization conditions used.

In a preferred embodiment, the liquid-tight film of the bag according to the present disclosure comprises, preferably consists of, is a multilayer polymer material. The multilayer polymer material can be prepared by coextrusion, e.g., in a blown-extrusion process, in a cast-extrusion process, or in an extrusion-laminating process, optionally after deposition, preferably chemical vapor deposition, of a barrier layer onto one of the films. Hence, the bag can have an innermost layer, wherein the innermost layer denotes the layer forming at least parts, preferably all of, the inner surface of the bag, and the bag can have an outermost layer, wherein the outermost layer denotes the layer forming at least parts, preferably all of, the outer surface of the bag.

The innermost layer usually has the function of providing inertia of the bag material in view of the active pharmaceutical ingredient. Hence, preferably, the material of the innermost layer is a material which prevents or at least reduces migration of compounds of the multilayer polymer material of the bag into the bag. Furthermore, the material of the innermost layer is preferably a material which prevents or at least reduces migration of compounds from the compounds in the bag, such as the active pharmaceutical ingredient, into the multilayer polymer material of the bag according to the present disclosure. Particularly preferably, the material of the innermost layer is a material, which prevents or at least reduces migration of an active pharmaceutical ingredient into the multilayer polymer material of the bag according to the present disclosure. Hence, most preferably, the material of the innermost layer of the bag according to the present disclosure is selected from the list consisting of a polypropylene, a polyethylene, or a cyclic olefin, more preferably is a cyclic olefin.

The function of the outermost layer or support layer of the multilayer polymer material of the bag according to the present disclosure is to provide impact protection from the environment to protect the at least two walls (2). Hence, preferably, the material of the outermost layer or support layer is a polymer material having improved mechanical properties, such as tensile strength, impact strength, and/or toughness. Hence, preferably, the material of the outermost layer or support layer of the liquid-tight multilayer film of the bag according to the present disclosure is a polyolefin material, most preferably is selected from a polyethylene or a polypropylene.

Hence, preferably, the at least one connection (6) is a welded connection, preferably a welded connection of the liquid-tight film comprising a polymer material, most preferably a welded seam of the liquid-tight film comprising a polymer material. Preferably, the at least one connection (5) has a sealing strength according to ASTM F88-94 of more than 0.85 N/mm, preferably more than 1.75 N/mm, and most preferably more than 2.5 N/mm. This ensures that the bag cannot be accidentally opened at the connection (6).

Preferably, the port (3) comprises a closure (15). This closure can be generally openable, such as peelable, breakable (i.e. by a twist-off or break-off cap), or openable by punctuating with a needle or spike. Thereby, two alternative embodiments of such a closure are described herein.

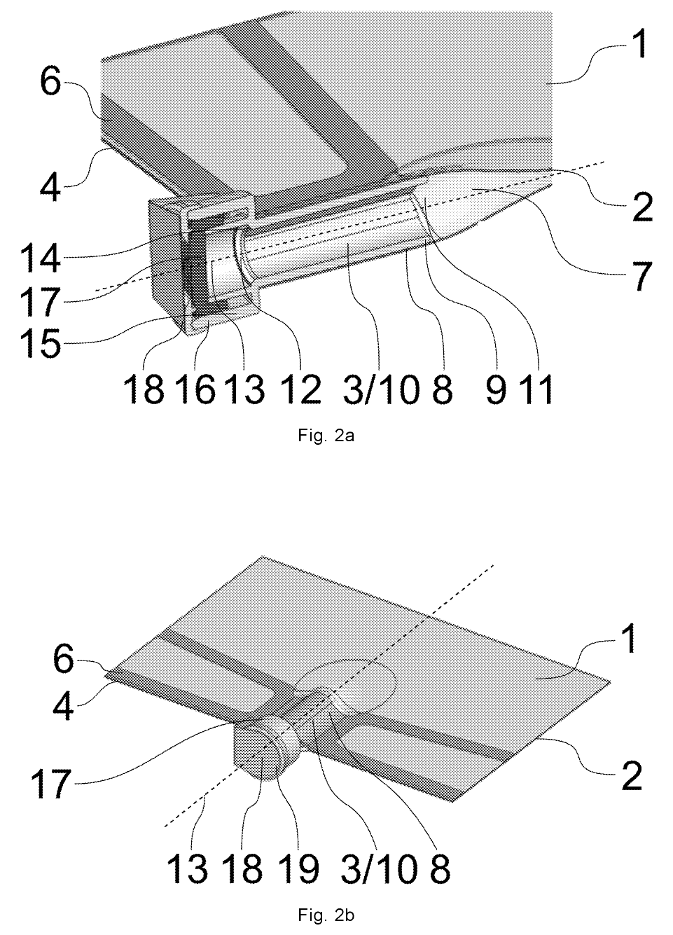

In a first preferred embodiment, the closure (15) is positioned outside of the inner port cavity (10) at the outlet opening (12) adjacent to the at least one port edge (14) defining the outlet opening (12). Such an embodiment is depicted in FIGS. 1a, 1b, 2a, 2b, 8a and 8b. The advantage of such an embodiment is that it is easy to be produced, as the shape is not too complex. Furthermore, the closure (15) can be formed in a way to be a plugin part for the port (3). Such an embodiment is shown in FIGS. 1a and 1b. However, closure (15) and port (3) can also be formed from one piece (e.g., FIGS. 2a and 3a). Another advantage in comparison to the later described second preferred embodiment is that the first preferred embodiment requires less barrier film to wrap the port. Furthermore, the gripping area is easier to handle.

However, this first preferred embodiment has the disadvantage that the closure (15) forms a surface (16) not covered by the two walls (2) (e.g., FIG. 1a), which again could increase permeation therethrough. To also reduce permeation through this surface (16), the surface (16) not covered by the two walls (2) comprises, preferably is completely covered by, a barrier layer or a binder-barrier mixed to the based material of the closure (15) as described below.

Usually, the closure (15) is made from a polymer material. Preferably, the closure (15) is produced by injection molding, molding compression or by co-injection. Preferred polymers used for the polymer material of the closure (15) are polyethylene or polypropylene, preferably polypropylene. The polypropylene of closure (15) is preferably a low melting meting polypropylene offering a good weldability on the barrier film.

In a preferred embodiment of the present disclosure, the polymer material of the closure (15) can already have barrier properties. Such barrier properties of the polymer material of the closure (15) can be provided for example by EVOH in combination with polypropylene or polyethylene. The use of a tie layer as individual layer or a binder mixed into the based material may be needed to achieve the adhesion with EVOH. Such an embodiment has the advantage that any permeation through the closure (15) can be further reduced.

Most preferably, the material of the port (3) and the material of the closure (15) are identical.

In a second preferred embodiment of the bag according to the present disclosure, the closure (15) is positioned in the inner port cavity (10), preferably positioned in the inner port cavity (10) adjacent to the at least one port edge (14) defining the outlet opening (12). Such an embodiment is shown in FIGS. 3a and 3b. Preferably, the closure (15) and the port (3) are produced from one piece and comprise the same material.

The second preferred embodiment has the advantage that it minimizes any surface exposed to contact with the environment.

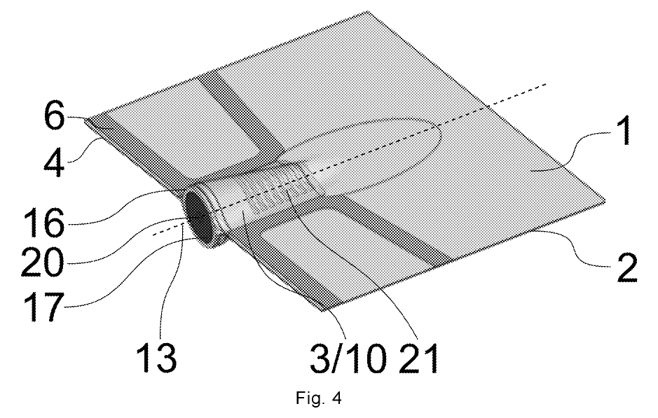

Preferably, in the first and the second preferred embodiment, the closure (15) comprises a rubber stopper (17). The rubber stopper (17) not only liquid-tightly closes the closure (15), but also provides means (20) to be punctuated for introducing or removing components from the bag, preferably to be punctuated by a spike. Embodiments including such rubber stopper (17) are depicted in FIGS. 1a, 2a, 3a,and 7. In other embodiments, the rubber stopper (17) can be attached to the closure (15) by overmolding the stopper (17) into the closure (15) (e.g., FIG. 4).

Usually, the rubber material of the rubber stopper (17) does not form a barrier for permeation. Moreover, the rubber material (17) is soft not easy to grip. Hence, preferably, the stopper (17) comprises a cap (18) to which tamper evidence means (19) are bound, preferably by a rupturable seam. The cap (18) and the tamper evidence means (19) ensure the integrity of the product and protect the rubber stopper (17) against dust. Preferably, the cap (18) comprises a hole for punctuation, which is covered and sealed by the tamper evidence means (19). The tamper evidence means (19) usually needs to be removed before punctuating the rubber stopper (17).

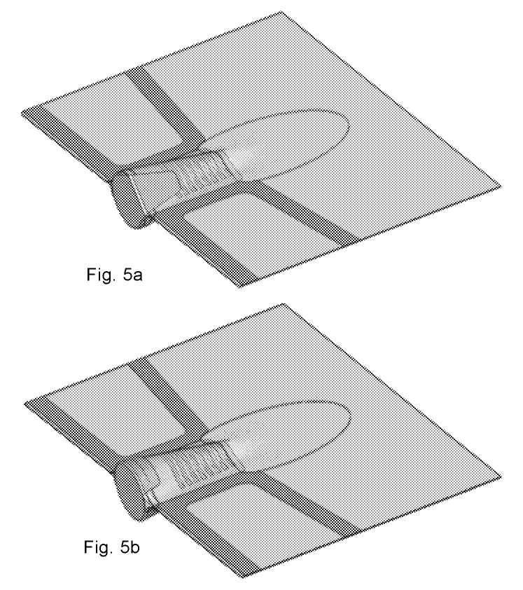

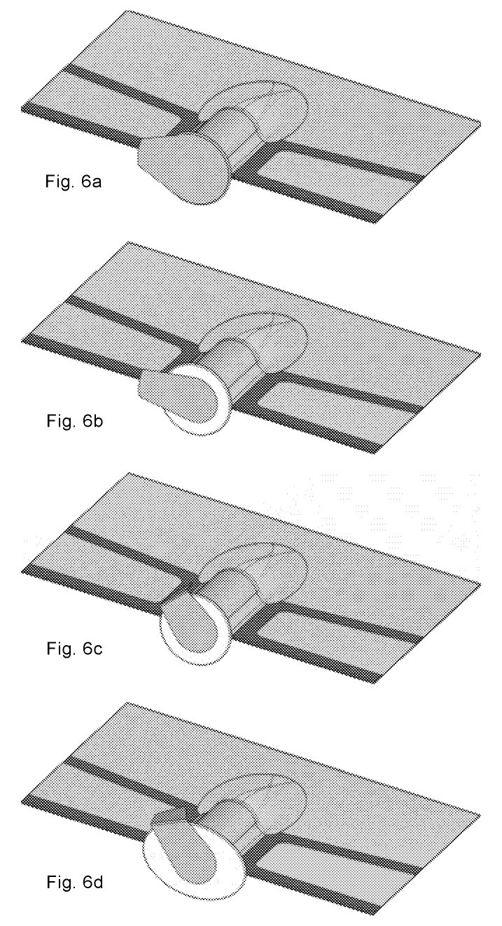

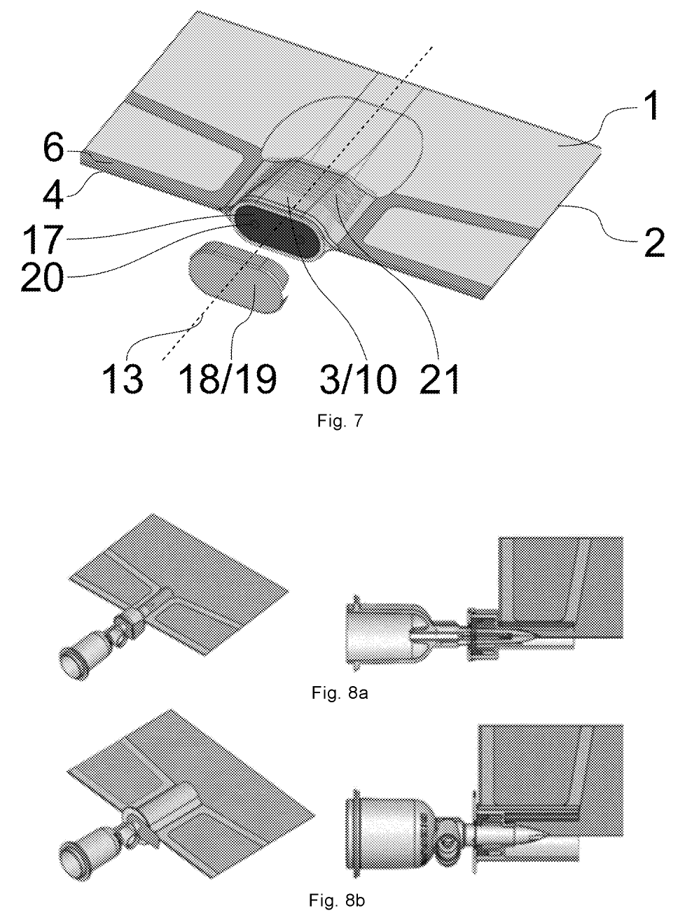

However, as already mentioned, rubber stoppers (17) are not offering a sufficient barrier for sensitive application. Hence, it is of advantage to immediately recognize if the tamper evidence (19) has already been removed beforehand or not. Thus, preferably, the closure (15) comprises tamper evidence means (19). The tamper evidence means (19) is preferably made from polyethylene terephthalate/silicon oxide, oriented polypropylene/silicon oxide, or atactic polypropylene. Thereby, the tamper evidence means can have several forms. It is only important that the tamper evidence means (19) is irreversibly destroyed upon opening the cap (18). Thereby, the tamper evidence means (19) can be welded or wrapped around the welded films and the port (e.g., FIGS. 5a and 5b). The tamper evidence means (19) can cover the complete cap or only parts therefrom (e.g., FIGS. 6a and 6b). Nevertheless, if the cap (18) comprises a hole for punctuating, the tamper evidence means (19) should cover and seal said hole. Preferably, the tamper evidence means (19) are folded and tilted (e.g., FIGS. 6c and 6d).

Preferably, the outlet opening (12) is formed as a seat for a spike. Such seats are inter alia depicted in FIGS. 3a, 8a and 8b. Hence, once a rubber stopper (17) has been punctuated by a spike, the spike will find good hold within the port (3) by the outlet opening (12).

### LIST OF REFERENCE SIGNS

1 Bag
2 Two walls of the bag
3 Port
4 Edge of the wall
5 Barrier layer (included in the walls (2); not explicitly shown in the figures)
6 Connection of the two walls
7 Inner cavity of the bag
8 Outer surface of the port
9 Port wall
10 Inner port cavity
11 Inlet opening of the port
12 Outlet opening of the port
13 Axis of the port
14 Port edge
15 Closure
16 Surface not covered by the two walls
17 Rubber stopper
18 Cap
19 Tamper evidence means
20 Seat spike
21 Ribs of the outer surface

1. A bag for housing a pharmaceutical product or a nutritional product, the bag comprising:
two walls; and
at least one port,
each of the two walls having at least one edge and a barrier layer,
the two walls being superimposed on each other,
the two walls being connected by at least one connection, thereby forming an inner cavity, and
at least 90% of an outer surface of the at least one port is covered by the barrier layer.

2. The bag according to claim 1, wherein the inner cavity comprises the pharmaceutical product or the nutritional product.

3. The bag according to claim 1, wherein the inner cavity is completely enclosed by the barrier layer.

4. The bag according to claim 1, wherein the at least one port comprises at least one port wall forming an inner port cavity,
the at least one port has an inlet opening and an outlet opening defining an axis of the at least one port,
wherein the at least one port is positioned between the two walls through the at least one connection,
wherein the inlet opening points towards the inner cavity of the bag.

5. The bag according to claim 4, wherein the inlet opening points towards a center of the inner cavity of the bag.

6. The bag according to claim 4, wherein:
the at least one port wall of the at least one port has at least one port edge defining the outlet opening, and
the at least one port edge and the at least one edge of each of the two walls are in alignment.

7. The bag according to claim 6, wherein the at least one port comprises a closure.

8. The bag according to claim 7, wherein the closure is positioned outside of the inner port cavity at the outlet opening adjacent to the at least one port edge defining the outlet opening.

9. The bag according to claim 8, wherein the closure forms a surface not covered by the two walls, wherein the surface not covered by the two walls comprises a barrier layer.

10. The bag according to claim 7, wherein the closure is positioned in the inner port cavity.

11. The bag according to claim 7, wherein the closure comprises tamper evidence means.

12. The bag according to claim 1, wherein each of the two walls has a rectangular shape.

13. The bag according to claim 1, wherein the two walls have an identical shape.

14. The bag according to claim 1, wherein the two walls are superimposed on each other so that the at least one edge of each of the two walls is in alignment.

15. The bag according to claim 1, wherein the at least one port is positioned so that an axis of the at least one port forms an angle in a range of 60° to 120° relative to an edge of the two walls that is closest to the at least one connection.

16. The bag according to claim 1, wherein the at least one port is positioned at a midpoint of the at least one edge of each of the two walls closest to the at least one connection.

17. The bag according to claim 1, wherein the at least one port has a tubular shape.

18. The bag according to claim 1, wherein the barrier layer comprises a material selected from ethylene vinyl alcohol or a metal oxide.

19. The bag according to claim 1, wherein the at least one connection is a welded connection.

20. The bag according to claim 19, wherein the welded connection comprises a liquid-tight film comprising a polymer material.
